(19) United States
(12) Patent Application Publication
(10) Pub. No.: US 2009/0002852 A1
(43) Pub. Date: Jan. 1, 2009

(54) ASSEMBLING METHOD FOR IMAGE DEVICE

(75) Inventor: TSUNG-CHIN WANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng,Taipei Hsien (TW)

(21) Appl. No.: 11/937,379

(22) Filed: Nov. 8, 2007

(30) Foreign Application Priority Data
Jun. 29, 2007 (CN) 200710200945.8

(51) Int. Cl. G02B 7/02

(52) U.S. Cl. 359/819

(57) ABSTRACT

An assembling method for an image device includes the following steps: assembling a lens to a body of the image device; assembling a housing having an opening to the body; applying an adhesive to a back of the lens ring or the rim around the periphery of the opening; and attaching the lens ring to the housing. The lens ring is capable of being fine adjusted to be coaxial with the central axis of the lens after the lens ring is assembled to the housing.

### TECHNICAL FIELD

The present invention relates to assembly of image devices and, particularly, to an assembling method for ensuring the central axis of a lens ring is coaxial with that of a lens of an image device.

### DESCRIPTION OF RELATED ART

For the assembly of an image device, it occurs that the central axis of a lens ring is not coaxial with that of a lens after the lens ring is assembled to a housing of the image device. This deteriorates image quality of the image device and decreases production speed and yield rate of the image device.

Referring to FIGS. 1-4, a typical image device is shown in these drawings. A lens 20 is disposed inside a body 100 of the image device. An opening 121 is defined in a housing 12 to receive the corresponding lens 20 therein. A plurality of holes 122 is formed around the periphery of the opening 121. A lens ring 10 has a plurality of pillars 11 to be received in the corresponding holes 122 during assembly of the lens ring 10 in the housing 12. Then, the sub-assembly of the lens ring 10 and the housing 12 is assembled to the body 100. Thus, the image device is obtained.

However, because the above-mentioned assembling process of the image device is so complex, and tolerances of individual components so strict, the central axis of the lens ring 10 may not be coaxial with that of the lens 20 after the sub-assembly of the lens ring 10 and the lens 20 is attached to the body 100. Thus, the cosmetic appearance of the image device is not only affected, but also it is more difficult to assemble the housing 12 to the body 100.

Therefore, it is desirable to provide an easy assembling method capable of ensuring the central axis of the lens ring is and remains coaxial with that of the lens during assembly of the lens ring onto the image device.

### SUMMARY

In accordance with a present embodiment, an assembling method for an image device includes the following steps: assembling a lens to a body of the image device; assembling a housing, defining an opening corresponding to the lens, to the body of the image device; applying an adhesive to the back of a lens ring or on the rim around the periphery of the opening; attaching the lens ring to the housing. The lens ring is aligned with the central axis of the lens and is positioned against a rim of the opening for attaching the lens ring to the housing. Before the adhesive is cured, the lens ring is capable of being finely adjusted to make the central axis of the lens ring coaxial with that of the lens after the lens ring is assembled to the housing.

Other advantages and novel features will be drawn from the following detailed description of at least one preferred embodiment, when considered conjunction with the attached drawings.

### BRIEF DESCRIPTION OF THE DRAWING

Many aspects of the present assembling method of an image device can be better understood with reference to the following drawings. The components in the drawings are not necessarily drawn to scale, the emphasis instead being placed upon clearly illustrating the principles of the present assembling method. Moreover, in the drawings, like reference numerals designate corresponding parts throughout the several views.

FIG. 1 is a perspective view of a lens ring and a housing of a typical image device;

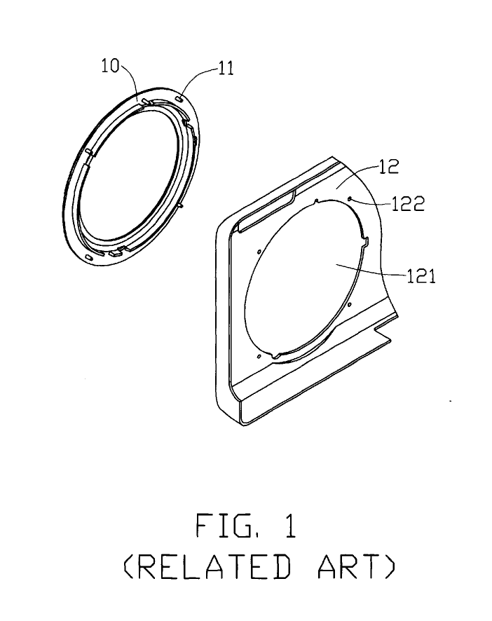

FIG. 2 is an assembled view of FIG. 1;

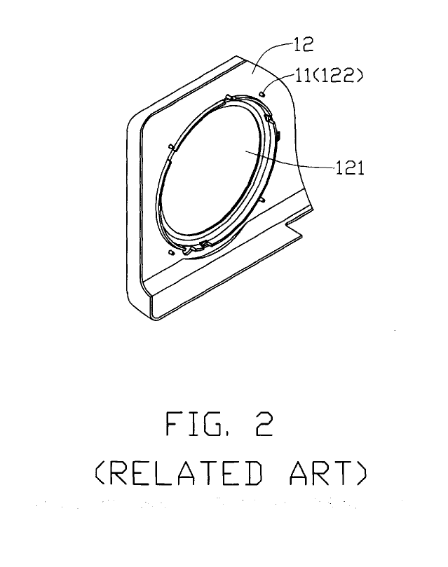

FIG. 3 is a perspective view of a body of the image device and a sub-assembly of the lens ring and the housing;

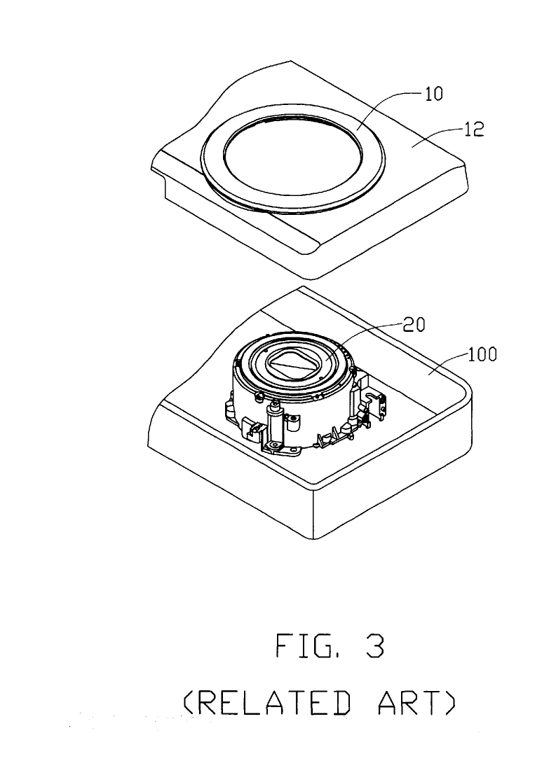

FIG. 4 is an assembled view of FIG. 3;

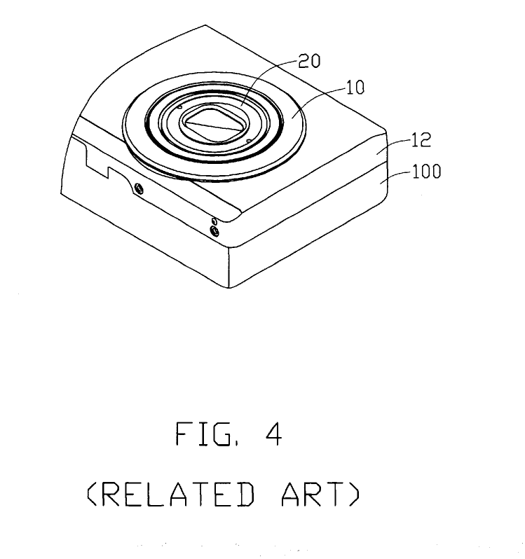

FIG. 5 is a flow chart of an assembly method of an image device, according to a present embodiment;

FIG. 6 is a perspective view of a housing and a body of the image device, according to a present embodiment;

FIG. 7 is an assembly view of FIG. 6;

FIG. 8 is a perspective view of a lens ring and the housing of the image device, showing an adhesive adhered to the periphery of the lens ring;

FIG. 9 is an assembled view of FIG. 8;

FIG. 10 is a cross-sectional view along line X-X of FIG. 9; and

FIG. 11 is an enlarged view of circled portion XI of FIG. 10.

### DETAILED DESCRIPTION OF THE EMBODIMENTS

Embodiments will now be described in detail below, with reference to the drawings.

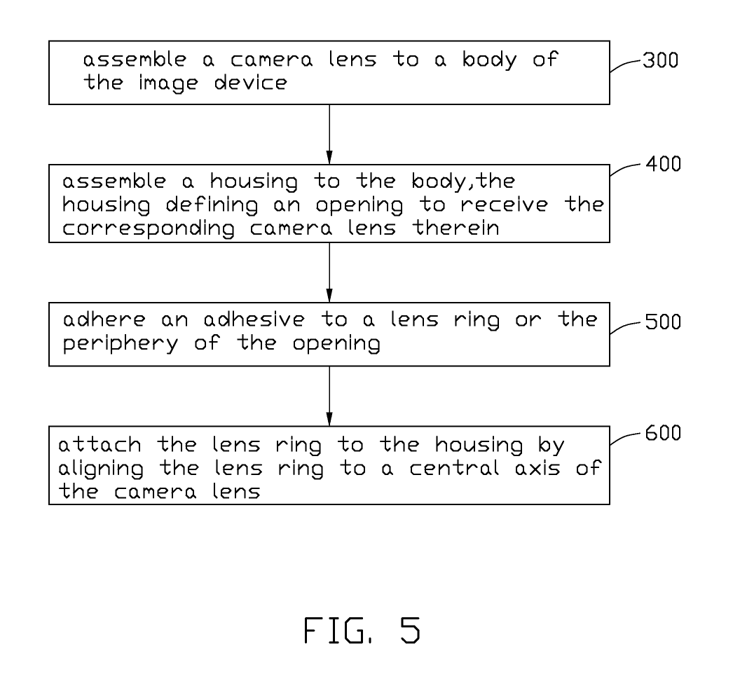

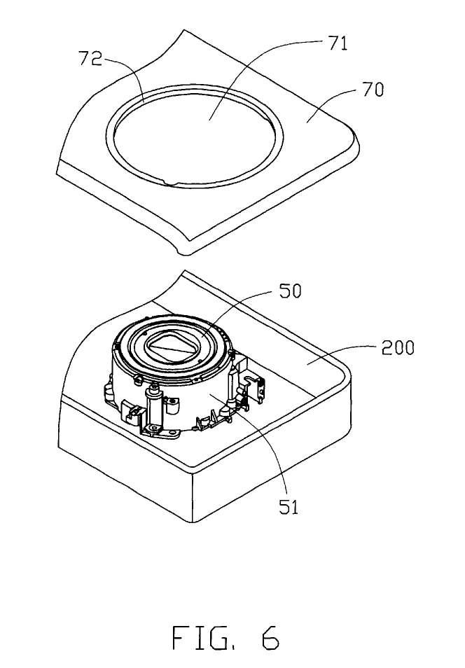

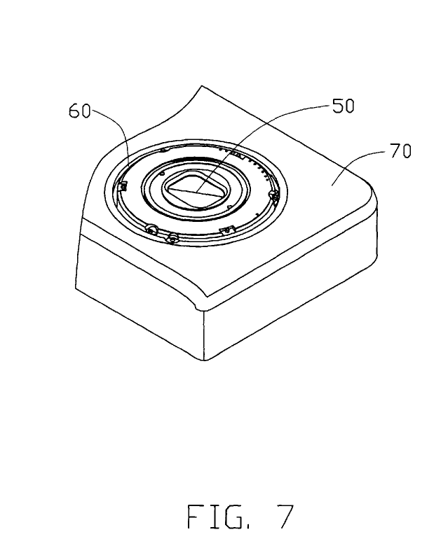

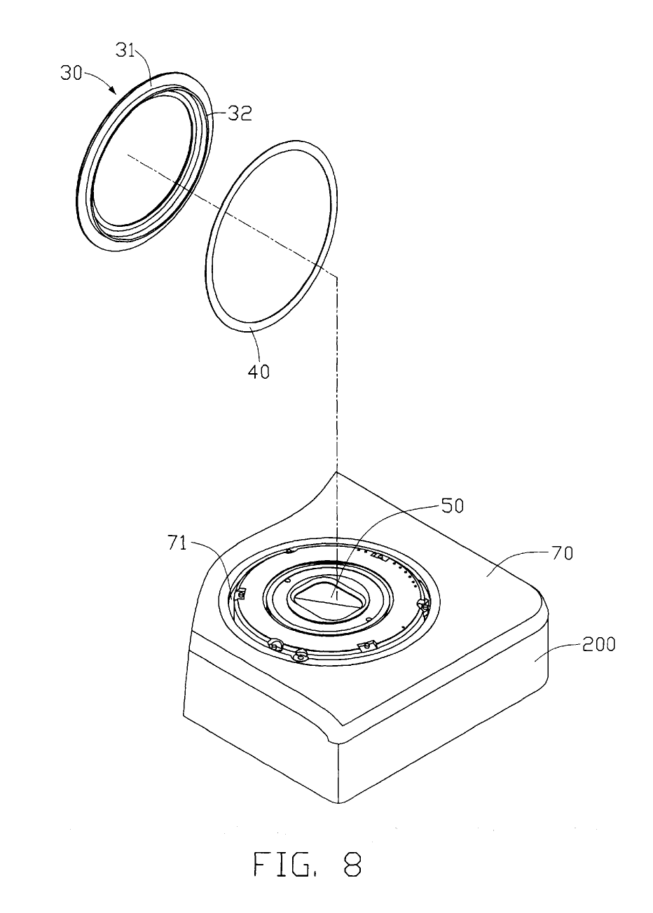

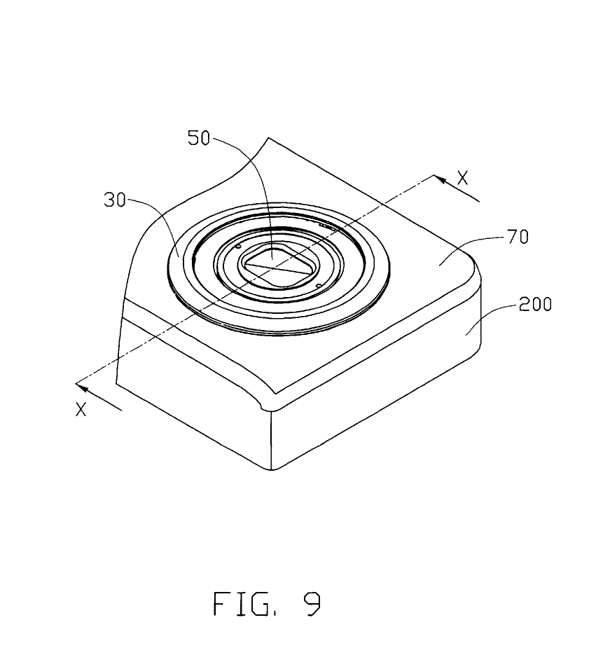

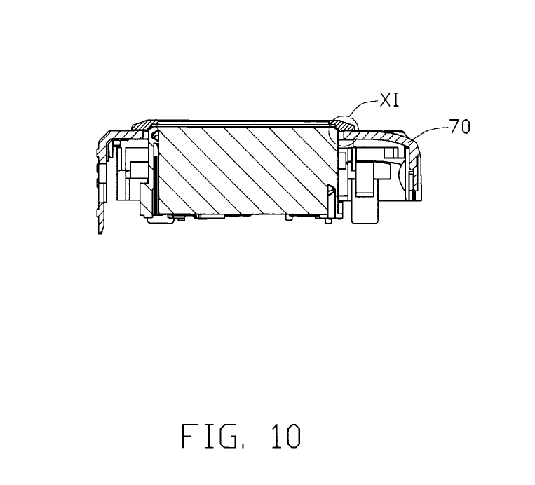

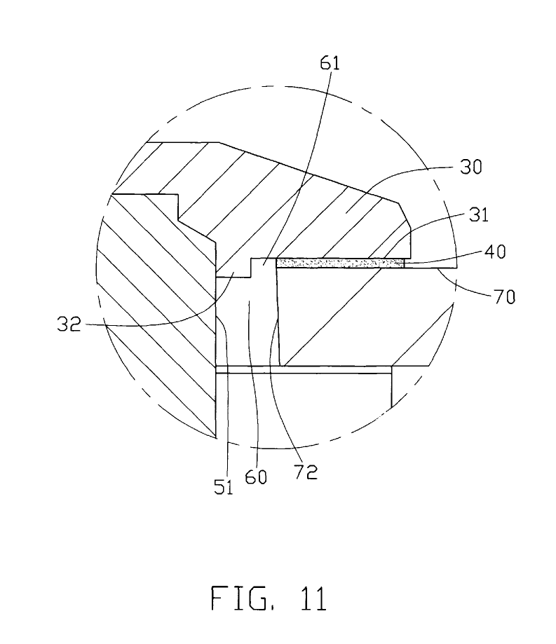

Referring to FIGS. 5-11, an assembling method of an image device according to a present embodiment is disclosed. The method includes the following steps: Step 300: assembling a lens 50 with a sidewall 51 to a body 200 of the image device;

Step 400: assembling a housing 70 to the body 200, the housing 70 defines an opening 71 to receive the corresponding lens 50 therein; wherein a rim 72 is formed around the periphery of the opening 71. When the housing 70 is assembled to the body 200, a gap 60 is formed between the rim 72 and the sidewall 51 of the lens 50. The diameter of the opening 71 is substantially equal to the sum of the diameter of the lens 50 and the width of the gap 60.

Step 500: applying an adhesive 40 to a lens ring 30 or on the rim around the periphery of the opening 71. In this embodiment, the adhesive 40 is double-sided tape applied to a back 31 of the lens ring 30. A ring 32 protrudes from the back 31 in the axial direction of the lens ring 30. The width of the ring 32 is less than that of the gap 60 and the height of the ring 32 is less than that of the rim 72. Accordingly, the lens ring 30 is capable of being engaged with the lens 50.

Step 600: attaching the lens ring 30 to the housing 70 by aligning the lens ring 30 to the central axis of the lens 50 and positioning the lens ring 30 against the rim 72 of the opening 71. Because the width of the ring 32 is less than that of the gap 60, the ring 32 is engagingly received inside the gap 60 when the lens ring 30 is attached to the housing 70. A clearance 61 with a width of 3˜5 millimeters is defined between the rim 72 and the ring 32. Preferably, the width of the clearance 61 is 4 millimeters. Before the adhesive 40 applied to the lens ring 30 is cured, the lens ring 30 is adjustable to make the central axis of the lens ring 30 coaxial with that of the lens 50 because the gap 60 allows room to maneuver the lens ring 30.

The assembling method of the presented embodiment allows fine adjustments to accurately position the central axis of the lens ring 30 coaxial with that of the lens 50.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An assembling method for an image device, the assembling method comprising:
assembling a lens to a body of the image device;
assembling a housing to the body of the image device, wherein the housing defines therein an opening to expose the lens, a gap being formed between a periphery of the lens and a boundary rim of the opening;
applying an adhesive to a lens ring or the rim of the opening;
attaching the lens ring to the housing to cover the gap.

2. The assembling method as claimed in claim 1, wherein the lens ring is attached at the rim of the opening with its central axis coaxial with that of the lens.

3. The assembling method as claimed in claim 2, further comprising curing the adhesive to adhere the lens ring to the housing.

4. The assembling method as claimed in claim 3, further comprising doing fine adjustments of the lens ring before the adhesive is cured.

5. An image device comprising:
a body;
a lens connected with the body, the lens defining a sidewall;
a housing assembled to the body, the housing defining an opening corresponding to the lens;
a rim disposed around the periphery of the opening, a gap formed between the rim and the sidewall;
a lens ring assembled to the housing to cover the gap, the lens ring comprising a back and a ring vertically protruding from the back, the back being face-to-face contacted with the housing.

6. The image device as claimed in claim 5, wherein the ring is received inside the gap.

7. The image device as claimed in claim 5, wherein an adhesive is applied on the back of the lens ring to adhere the back of the lens to the housing.

8. The image device as claimed in claim 5, wherein an adhesive is applied on the rim around the periphery of the opening to adhere the back of the lens to the housing.

9. The image device as claimed in claim 5, wherein a width of the ring is less than that of the gap and a height of the ring is less than that of the rim.

10. The image device as claimed in claim 9, wherein a clearance with a width of 3˜5 millimeter is defined between the rim and the ring.

11. The image device as claimed in claim 10, wherein the width of the clearance is 4 millimeter.
